(19) United States
(12) Patent Application Publication
(10) Pub. No.: US 2008/0218667 A1
(43) Pub. Date: Sep. 11, 2008

(54) LIQUID CRYSTAL DISPLAY DEVICE CAPABLE OF MAKING BOUNDARY OF DISPLAY AREA AND PICTURE FRAME AREA UNREMARKABLE

(75) Inventor: Keiji TAGO, Fukaya-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Toshiba Matsushita Display Technology Co., Ltd., Tokyo (JP)

(21) Appl. No.: 11/938,531

(22) Filed: Nov. 12, 2007

(30) Foreign Application Priority Data
Mar. 5, 2007 (JP) 2007-054731

(51) Int. Cl. G02F 1/1335

(52) U.S. Cl. 349/106

(57) ABSTRACT

In the liquid crystal display device, the overcoat layer enters the area where a color filter layer is not formed. The opposing substrate when the overcoat layer is formed is thin. This makes the difference between the cell-gap length in the display area and the cell-gap length in the picture frame area become small.

### CROSS-REFERENCE TO RELATED APPLICATIONS

This application is based upon and claims the benefit of priority from Japanese Patent Application No. 2007-054731 filed on Mar. 5, 2007; the entire contents of which are incorporated herein by reference.

### BACKGROUND OF THE INVENTION

1. Field of the Invention

The present invention relates to a liquid crystal display device capable of making a boundary of a display area and a picture frame area unremarkable.

2. Description of the Related Art

In recent years, a semi-transmissive type liquid crystal display device, which has transmissive display areas and reflective display areas, is used in a mobile information device such as a mobile phone and a mobile music player.

One such device having a picture frame area around a display area is known. In the device, there might be a difference between a length of a gap of substrates, hereinafter referred to as a cell-gap length, in the display area and a cell-gap length in the picture frame area. This brings a difference in reflectance and chromaticity. A big difference in chromaticity makes a boundary of the display area and the picture frame area become remarkable, and a display panel does not look good.

### SUMMARY OF THE INVENTION

A liquid crystal display device according to the present invention is characterized by including: a display panel having an array substrate, an opposing substrate and a liquid crystal layer formed between the array substrate and the opposing substrate, the display panel having a display area which has display pixels, the display area being surrounded by a picture frame area which has dummy pixels, each of the display pixels and the dummy pixels having a first area and a second area; transparent electrodes formed in the array substrate, the transparent electrodes being formed in the second areas of the display pixels respectively; reflective electrodes formed in the array substrate, the reflective electrodes being formed in the first areas of the display pixels and in the first areas of the dummy pixels respectively; a light-block layer capable of blocking light, the light-block layer being formed in the opposing substrate, the light-block layer being formed in the second areas of the dummy pixels; a color filter layer capable of adding color to light, the color filter layer being formed in the opposing substrate, the color filter layer being formed in the first areas of the display pixels, in the second areas of the display pixels and in the first areas of the dummy pixels, each of the second areas of the dummy pixels having an area where a color filter layer is not formed; and a transparent overcoat layer formed on the light-block layer and the color filter layer.

In the present invention, the overcoat layer enters the area where a color filter layer is not formed. Because of this, the opposing substrate when the overcoat layer is formed is thin. This makes a difference between a cell-gap length in the display area and a cell-gap length in the picture frame area become small. The small difference in cell-gap length makes a difference between a reflectance in the display area and a reflectance in the picture frame area become small. The small difference in reflectance makes a difference between a chromaticity in the display area and a chromaticity in the picture frame area become small. As a result, a boundary of the display area and the picture frame area becomes unremarkable, and the display panel looks good.

### BRIEF DESCRIPTION OF THE DRAWINGS

FIG. 1 illustrates a plan view of a display panel of a liquid crystal display device according to an embodiment of a present invention;

FIG. 2 illustrates an enlarged plan view of an area 14 in FIG. 1 which includes a part of a boundary of a display area 11 and a picture frame area 12;

FIG. 3 illustrates a cross section view where marks III in FIG. 2 designate;

FIG. 4 illustrates a cross section view where marks IV in FIG. 2 designate;

FIG. 5 illustrates a cross section view where marks V in FIG. 2 designate;

FIG. 6 illustrates a plan view of an area of a comparative example, the area including a part of a boundary of a display area and a picture frame area.

FIG. 7 illustrates a cross section view where marks VII in FIG. 6 designate;

FIG. 8 illustrates a cross section view where marks VIII in FIG. 6 designate;

### DESCRIPTION OF THE EMBODIMENT

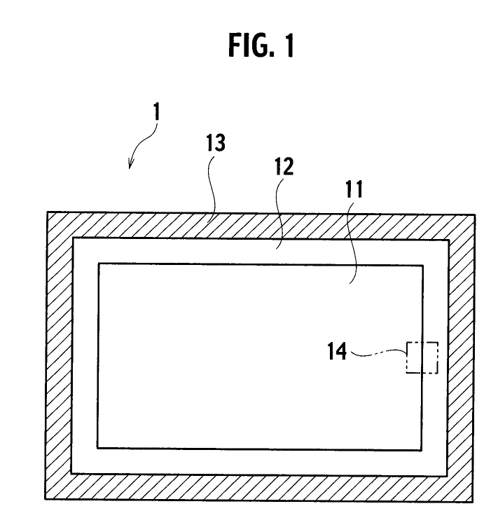

As illustrated in FIG. 1, the display panel 1 of the liquid crystal display device according to the embodiment of the present invention has a display area 11, a picture frame area 12 surrounding the display area 11, and a picture frame area 13 surrounding the picture frame area 12.

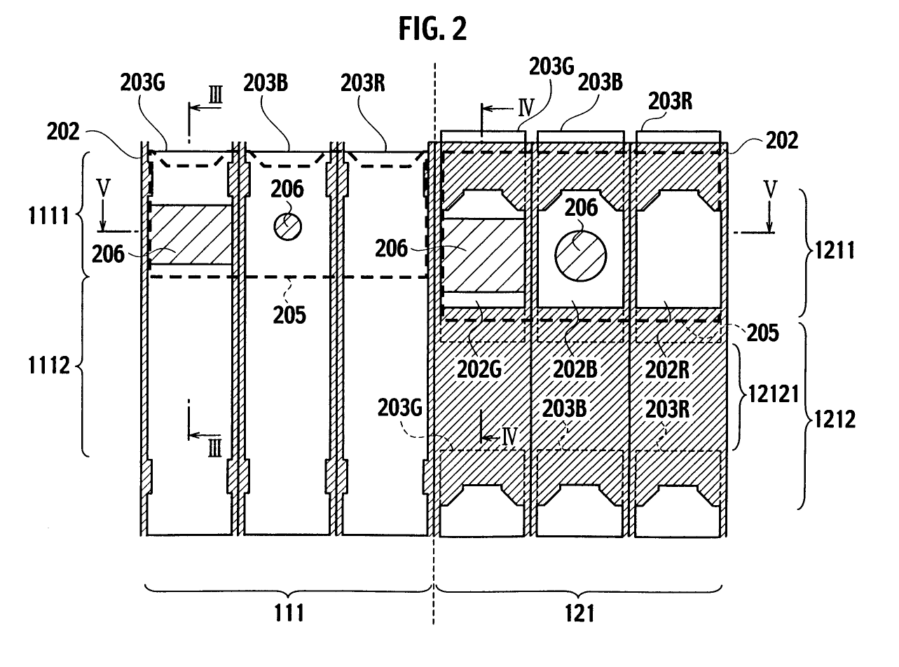

As illustrated in FIG. 2, the area 14 has a display pixel 111 and a dummy pixel 121. The display area 11 has the display pixels 111. The picture frame area 12 has the dummy pixels 121.

The display pixel 111 has a first area 1111 and a second area 1112. The dummy pixel 121 has a first area 1211 and a second area 1212.

A transparent cell-gap adjusting layer 205 is formed in the first area 1111 and in the first area 1211.

A black matrix layer 202, which is a light-block layer capable of blocking light, is formed in the first area 1211 and in the second area 1212. The black matrix layer 202 has openings 202G, 202B and 202R in the first area 1211.

A color filter layer 203G capable of adding green color to light, a color filter layer 203B capable of adding blue color to light, and a color filter layer 203R capable of adding red color to light are formed in each of the first area 1111, the second area 1112, the first area 1211 and the second area 1212.

The second area 1212 has an area 12121 where a color filter layer is not formed.

Each of the color filter layer 203G in the first area 1111 and the color filter layer 203B in the first area 1111 has a transparent area 206 where a color filter layer is not formed.

The color filter layer 203G in the first area 1211 lays over the opening 202G. The color filter layer 203B in the first area 1211 lays over the opening 202B. The color filter layer 203R in the first area 1211 lays over the opening 202R.

Each of the color filter layer 203G laying over the opening 202G and the color filter 203B laying over the opening 202B has a transparent area 206.

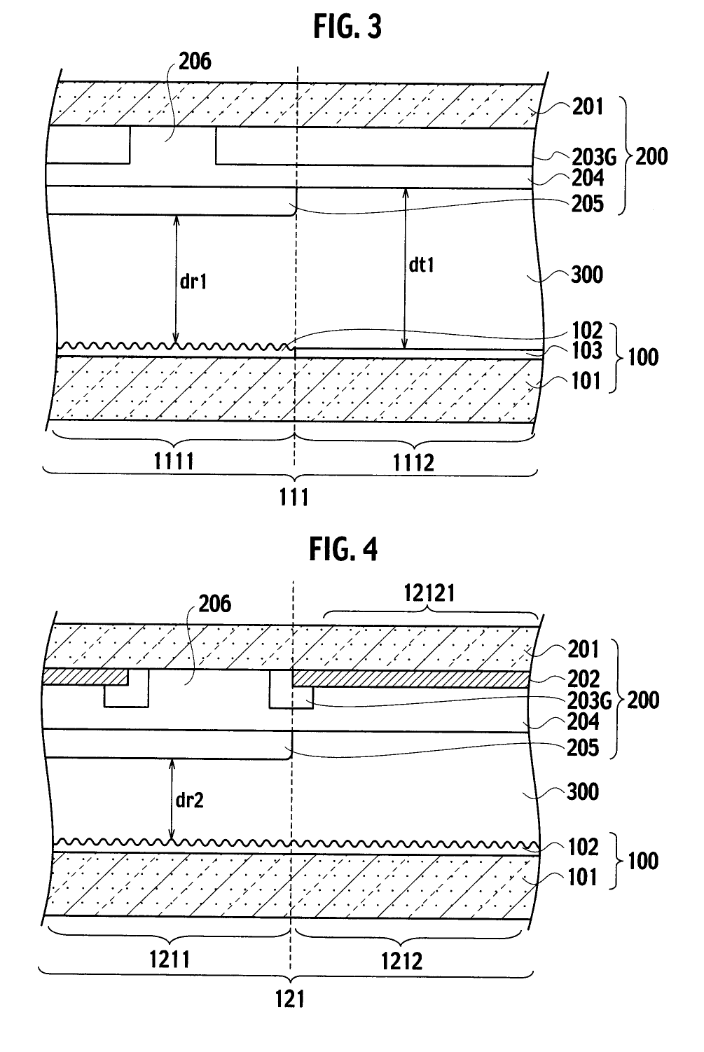

As illustrated in FIG. 3, the display panel 1 has an array substrate 100, an opposing substrate 200 and a liquid crystal layer 300 formed between the array substrate 100 and the opposing substrate 200.

A reflective electrode 102 having ruggedness is formed on a glass substrate 101 of the array substrate 100, the reflective electrode 102 being formed in the first area 1111. A transparent electrode 103 is formed on the glass substrate 101, the transparent electrode 103 being formed in the second area 1112.

Although not illustrated, a thin film transistor, a signal line, a scanning line, and the likes are formed in the array substrate 100.

The color filter 203G is formed on a glass substrate 201 of the opposing substrate 200, the color filter 203G being formed in the first area 1111 and in the second area 1112. The color filter layer 203G in the first area 1111 has the transparent area 206.

A transparent overcoat layer 204 is formed on the color filter layer 203G. The overcoat layer 204 enters the transparent area 206 where a color filter layer is not formed. The overcoat layer 204 makes a surface of the opposing substrate 300 flat and smooth.

The cell-gap adjusting layer 205 is formed on the overcoat layer 204, the cell-gap adjusting layer 205 being formed in the first area 1111.

Although not illustrated, an opposite electrode, and the likes are formed in the opposing substrate 200.

A cell-gap length dr1 in the first area 1111 is shorter than a cell-gap length dt1 in the first area 1112. That is, the display pixel 111 has a multi-gap structure.

As illustrated in FIG. 4, the reflective electrode 102 is formed on the glass substrate 101, the reflective electrode 102 being formed in the first area 1211 and in the second area 1212.

Although not illustrated, a thin film transistor, a signal line, a scanning line, and the likes are formed in the array substrate 100.

The black matrix layer 202 is formed on the glass substrate 201, the black matrix layer 202 being formed in the second area 1212.

The color filter 203G is formed on the glass substrate 201, the color filter 203G being formed in the first area 1211. The color filter layer 203G in the first area 1211 has the transparent area 206.

The overcoat layer 204 is formed on the black matrix layer 202 and the color filter layer 203G. The overcoat layer 204 enters the transparent area 206 and the area 12121 where a color filter layer is not formed. The overcoat layer 204 makes a surface of the opposing substrate 300 flat and smooth.

The cell-gap adjusting layer 205 is formed on the overcoat layer 204, the cell-gap adjusting layer 205 being formed in the first area 1211.

Although not illustrated, the opposite electrode, and the likes are formed in the opposing substrate 200.

A cell-gap length dr2 is a cell-gap length in the first area 1211.

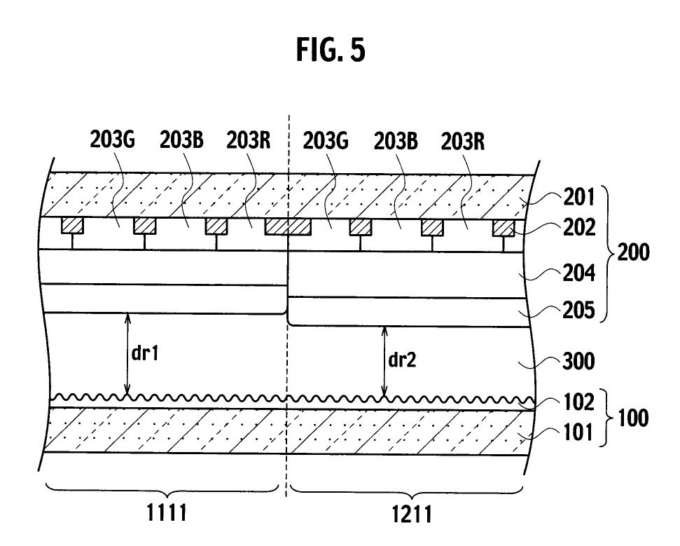

As illustrated in FIG. 5, the reflective electrode 102 is formed on the glass substrate 101, the reflective electrode 102 being formed in the first area 1111 and in the first area 1211.

Although not illustrated, a thin film transistor, a signal line, a scanning line, and the likes are formed in the array substrate 100.

The color filters 203G, 203B and 203R are formed on the glass substrate 201, the color filters 203G, 203B and 203R being formed in each of the first area 1111 and the first area 1211.

The overcoat layer 204 is formed on the color filter layers 203G, 203B and 203R.

The cell-gap adjusting layer 205 is formed on the overcoat layer 204, the cell-gap adjusting layer 205 being formed in the first area 1111 and in the first area 1211.

Although not illustrated, the opposite electrode, and the likes are formed in the opposing substrate 200.

The cell-gap length dr1 is a cell-gap length in the first area 1111. The cell-gap length dr2 is a cell-gap length in the first area 1211.

The liquid crystal display device is a normally white mode device. That is, the liquid crystal display device is configured to make the display area 11 look white if voltage is not added to the liquid crystal layer 300.

The liquid crystal display device displays an image in the display area 11, adding voltage to the liquid crystal layer 300. At this time, lights reflected at the reflective electrodes 102 in the first areas 1111 are used for example.

The liquid crystal display device always makes the picture frame area 12 look white, adding no voltage to the liquid crystal layer 300. At this time, lights reflected at the reflective electrodes 102 in the first areas 1211 are used.

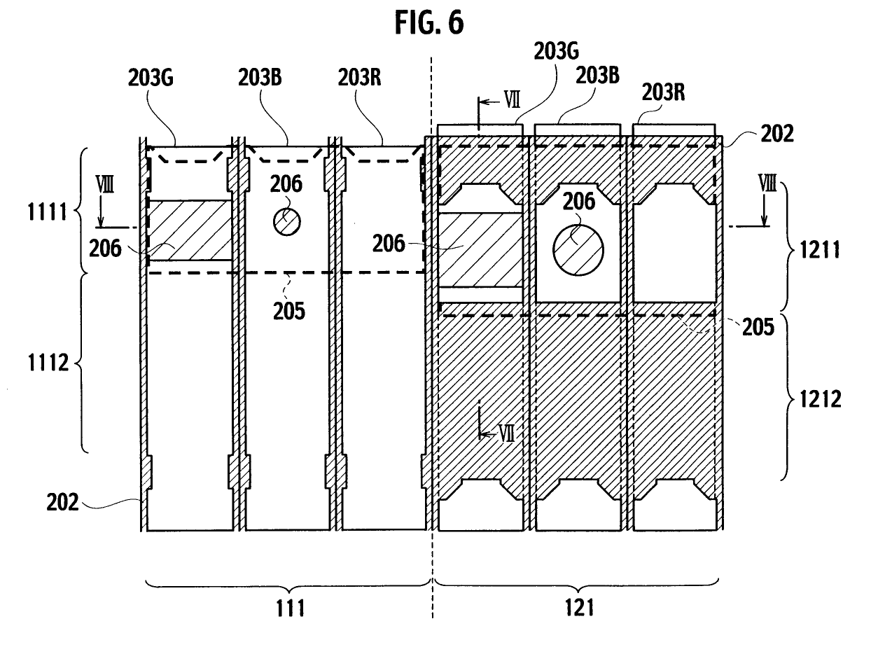

As illustrated in FIG. 6, in a comparative example, the second area 1212 does not have such area as the area 12121 in FIG. 2 where a color filter layer is not formed. Others are same as those in FIG. 2.

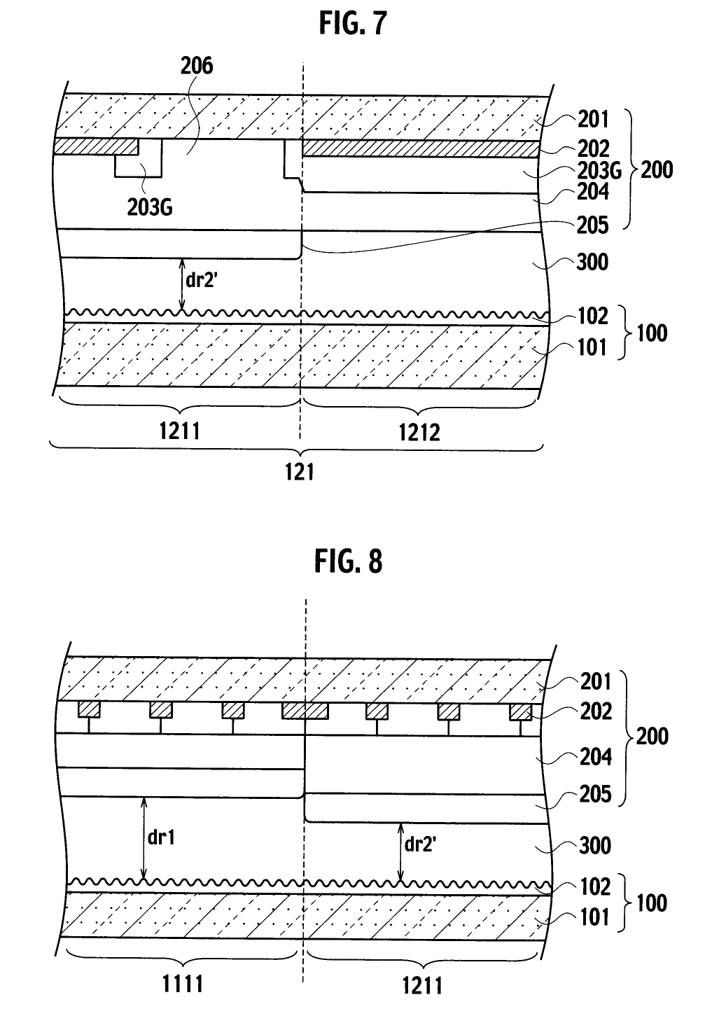

As illustrated in FIG. 7, the color filter layer 203G is formed in all the second area 1212. Others are same as those in FIG. 4.

Since there is not such area as the area 12121 in the comparative example, the opposing substrate 200 is already thick when the overcoat layer 204 is formed, and a cell-gap length dr2′, which is a cell-gap length in the first area 1211, is short.

If a cell-gap length is short, a reflectance becomes low. Because of this, the picture frame area 12, where no voltage is always added to the liquid crystal layer 300, may be seen blue-like-white though white should be seen.

On the contrary, if a cell-gap length is long, a reflectance becomes high. Because of this, the display area 11, if voltage is not added to the liquid crystal layer 300, may be seen yellow like white though white should be seen.

Such phenomenon happens in the comparative example since the difference between the cell-gap length dr1 and dr2′ is comparatively big.

That is, in the comparative example, the boundary of the display area 11 and the picture frame area 12 is remarkable, and the display panel does not look good.

On the contrary, in the liquid crystal display device according to the embodiment, since the overcoat layer 204 enters the area 12121, the opposing substrate 200 when the overcoat layer 204 is formed is thin, and a cell-gap length dr2, which is a cell-gap length in the first area 1211, is long.

This makes the difference between the cell-gap length dr1 and dr2 be smaller than the difference between the cell-gap length dr1 and dr2′.

Because of this, a difference between a reflectance in the display area 11 and a reflectance in the picture frame area 12 is comparatively small. And, even if there is a difference between a chromaticity in the display area 11 and chromaticity in the picture frame area 12, the difference in chromaticity is comparatively small.

As a result, in the liquid crystal display device according to the embodiment, the boundary of the display area 11 and the picture frame area 12 is unremarkable, and the display panel looks good.

As illustrated in FIG. 5, the cell-gap length dr2 may not equal to the cell-gap length dr1.

A measure against this can be taken as follows.

It is assumed that each of the color filter layer 203R in the first area 1111 and the color filter layer 203R laying over the opening 202R has a transparent area 206.

It is also assumed that a size of the color filter 203G in the first area 1111 is S1(203G), a size of the transparent area 206 in the color filter 203G in the first area 1111 is S1(206G), a size of the opening 202G is S2(202G), a size of the transparent area 206 in the opening 202G is S2(206G), a size of the color filter 203B in the first area 1111 is S1(203B), a size of the transparent area 206 in the color filter 203B in the first area 1111 is S1(206B), a size of the opening 202B is S2(202B), a size of the transparent area 206 in the opening 202B is S2(206B), a size of the color filter 203R in the first area 1111 is S1(203R), a size of the transparent area 206 in the color filter 203R in the first area 1111 is S1(206R), a size of the opening 202R is S2(202R), a size of the transparent area 206 in the opening 202R is S2(206R).

As illustrated in FIG. 2, if S1(203G), S2(202G), S1(203B), S2(202B), S1(203R), S2(202R) are almost the same, there are following relations.

R1(G)=S1(206G)/S1(203G)

R2(G)=S2(206G)/S2(202G)

R1(G) is equal to or less than R2(G)

R1(B)=S1(206B)/S1(203B)

R2(B)=S2(206B)/S2(202B)

R1(B) is equal to or less than R2(B)

R1(R)=S1(206R)/S1(203R)

R2(R)=S2(206R)/S2(202R)

R1(R) is equal to or less than R2(R)

R1(G), R1(B), R1(R) are different from each other. R2(G), R2(B), R2(R) are different from each other.

That is, by adjusting R1(G), R1(B), R1(R), R2(G), R2(B), R2(R) hereinafter collectively referred to as transparent area ratios, separately, the boundary of the display area 11 and the picture frame area 12 is unremarkable, and the display panel looks good even if the cell-gap length dr2 is not equal to the cell-gap length dr1.

On the contrary, if S1(203G)<S2(202G), S1(203B)<S2(202B), S1(203R)<S2(202R), there are following relations.

R1(G) is equal to or more than R2(G)

R1(B) is equal to or less than R2(B)

R1(R) is equal to or more than R2(R)

R1(G), R1(B), R1(R) are different from each other. R2(G), R2(B), R2(R) are different from each other.

That is, by adjusting the transparent area ratios separately on basis of a difference between a size of the color filter in the first area 1111 and a size of the opening in the first area 1211, the boundary of the display area 11 and the picture frame area 12 is unremarkable, and the display panel looks good even if the cell-gap length dr2 is not equal to the cell-gap length dr1.

What is claimed is:

1. A liquid crystal display device comprising:
a display panel having an array substrate, an opposing substrate and a liquid crystal layer formed between the array substrate and the opposing substrate, the display panel having a display area which has display pixels, the display area being surrounded by a picture frame area which has dummy pixels, each of the display pixels and the dummy pixels having a first area and a second area;
transparent electrodes formed in the array substrate, the transparent electrodes being formed in the second areas of the display pixels respectively;
reflective electrodes formed in the array substrate, the reflective electrodes being formed in the first areas of the display pixels and in the first areas of the dummy pixels respectively;
a light-block layer capable of blocking light, the light-block layer being formed in the opposing substrate, the light-block layer being formed in the second areas of the dummy pixels;
a color filter layer capable of adding color to light, the color filter layer being formed in the opposing substrate, the color filter layer being formed in the first areas of the display pixels, in the second areas of the display pixels and in the first areas of the dummy pixels, each of the second areas of the dummy pixels having an area where a color filter layer is not formed; and
a transparent overcoat layer formed on the light-block layer and the color filter layer.

2. The liquid crystal display device according to claim 1, wherein the liquid crystal display device is a normally white mode device, the liquid crystal display device being configured to make the picture frame area look white.

3. The liquid crystal display device according to claim 1, wherein a transparent cell-gap adjusting layer is formed on the overcoat layer, the cell-gap adjusting layer being formed in the first areas of the display pixels and in the first areas of the dummy pixels.
